(19) United States
(12) Patent Application Publication
(10) Pub. No.: US 2011/0137922 A1
(43) Pub. Date: Jun. 9, 2011

(54) AUTOMATIC GENERATION OF A QUERY LINEAGE

(75) Inventors: David D. Cushing, Ottawa (CA); Martin M. Petitclerc, Quebec (CA)

(73) Assignee: INTERNATIONAL BUSINESS MACHINES CORPORATION, Armonk, NY (US)

(21) Appl. No.: 12/632,278

(22) Filed: Dec. 7, 2009

(51) Int. Cl. G06F 17/30

(52) U.S. Cl. 707/755; 707/E17.136

(57) ABSTRACT

A method of generating a query lineage is provided. The method includes, performing on a processor, evaluating at least one of query tree information and operations performed on a query tree, where the query tree includes one or more nodes; identifying a lineage rule based on the at least one of query tree information and operations; and generating a lineage of the query tree based on the lineage rule.

### BACKGROUND

The present invention relates to systems, methods, and computer program products for automatically generating a query lineage.

During the query planning and optimization phases of generating an execution plan for a database query, a query is typically represented in some form of tree. Rules are applied to the query tree that, first, ensure the correct data is retrieved, and secondly, that the data is retrieved as efficiently and as quickly as possible. These rules ensure semantic equivalence of the query tree before and after the application of a rule.

At any time during this process, it may be desirable to be able to determine the relationship between a construct in the original query and what is related to it in the current state of the query tree and, similarly, the relationship between a construct in the current query tree and constructs in the original query. This information is called ‘lineage’ and allows any object within the query tree to trace back its ancestors (its ‘lineage’) in the original query.

### SUMMARY

In an exemplary embodiment, a method of generating a query lineage is provided. The method includes, performing on a processor, evaluating at least one of query tree information and operations performed on a query tree, where the query tree includes one or more nodes; identifying a lineage rule based on the at least one of query tree information and operations; and generating a lineage of the query tree based on the lineage rule.

### BRIEF DESCRIPTION OF THE SEVERAL VIEWS OF THE DRAWINGS

The drawings described herein are for illustration purposes only and are not intended to limit the scope of the present disclosure in any way. It should be understood that throughout the drawings, corresponding reference numerals indicate like or corresponding parts and features.

FIG. 1 is a block diagram illustrating a computing system that includes a lineage generation system in accordance with an exemplary embodiment.

FIGS. 2 and 3 are dataflow diagrams illustrating the lineage generation system of FIG. 1 in accordance with an exemplary embodiment.

FIGS. 4A-4C illustrate various query trees and lineages that result from the lineage generation system of FIG. 1 based on various operations in accordance with an exemplary embodiment.

FIG. 5 is a flowchart illustrating a lineage generation method in accordance with an exemplary embodiment.

### DETAILED DESCRIPTION

In accordance with an exemplary embodiment of the present invention, a lineage generation system that automates the generation of lineages for database query trees is provided. As can be appreciated, the following description is merely exemplary in nature and is not intended to limit the present disclosure, application, or uses. It should be understood that throughout the drawings, corresponding reference numerals indicate like or corresponding parts and features.

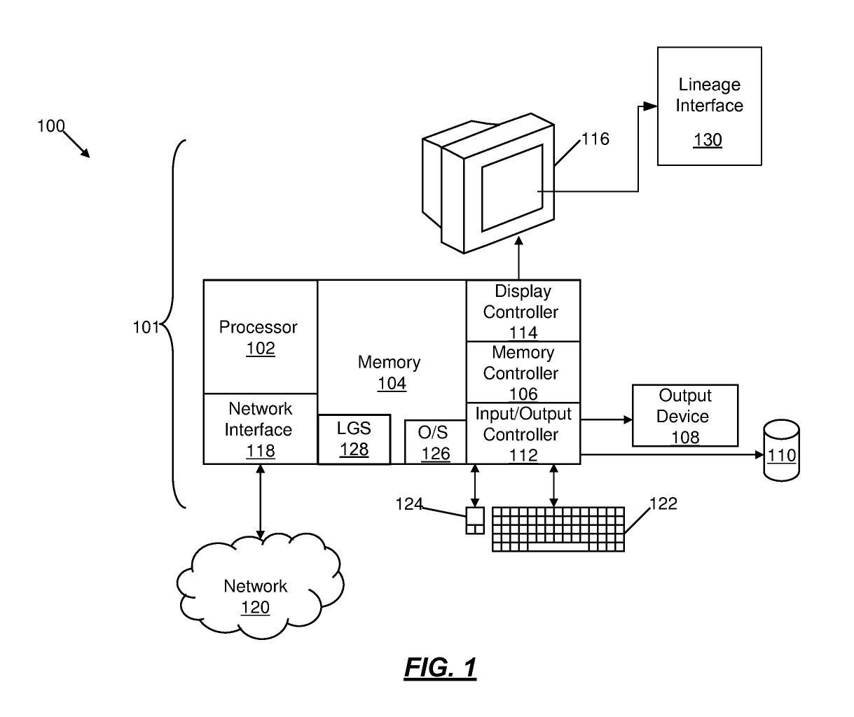

Turning now to FIG. 1, the block diagram illustrates an exemplary computing system 100 that includes a lineage generation system (LGS) in accordance with the present disclosure. The computing system 100 is shown to include a computer 101. As can be appreciated, the computing system 100 can include any computing device, including, but not limited to, a desktop computer, a laptop, a server, a portable handheld device, or any other electronic device. For ease of the discussion, the disclosure will be discussed in the context of the computer 101.

The computer 101 is shown to include a processor 102, memory 104 coupled to a memory controller 106, one or more input and/or output (I/O) devices 108, 110 (or peripherals) that are communicatively coupled via a local input/output controller 112, and a display controller 114 coupled to a display 116. In an exemplary embodiment, a conventional keyboard 122 and mouse 124 can be coupled to the input/output controller 112. In an exemplary embodiment, the computing system 100 can further include a network interface 118 for coupling to a network 120. The network 120 transmits and receives data between the computer 101 and external systems, such as other computing systems (not shown) that similarly include the login generation system of the present disclosure.

In various embodiments, the memory 104 stores instructions that can be performed by the processor 102. The instructions stored in memory 104 may include one or more separate programs, each of which comprises an ordered listing of executable instructions for implementing logical functions. In the example of FIG. 1, the instructions stored in the memory 104 include a suitable operating system (OS) 126. The opting system 126 essentially controls the performance of other computer programs and provides scheduling, input-output control, file and data management, memory management, and communication control and related services.

When the computer 101 is in operation, the processor 102 is configured to execute the instructions stored within the memory 104, to communicate data to and from the memory 104, and to generally control operations of the computer 101 pursuant to the instructions. The processor 102 can be any custom made or commercially available processor, a central processing unit (CPU), an auxiliary processor among several processors associated with the computer 101, a semiconductor based microprocessor (in the form of a microchip or chip set), a macroprocessor, or generally any device for executing instructions.

The processor 102 executes the instructions of the lineage generation system 128 of the present disclosure. In various embodiments, the lineage generation system 128 of the present disclosure is embedded in some form of computer readable medium, for example, the lineage generation system 128 is stored in the memory 104 (as shown), is performed from a portable storage device (e.g., CD-ROM, Diskette, FlashDrive, etc.) (not shown), and/or is run from a remote location, such as from a central server (not shown).

Generally speaking, the lineage generation system 128 generates a lineage of a query performed on, for example, a database. In various embodiments, the lineage generation system 128 can be provided within a new or existing query planning or optimization engine. In various other embodiments, the lineage generation system 128 can be implemented as a stand-alone application, a plug-in application, and/or any other type of application as applicable and in accordance with the present disclosure. The lineage generation system 128 yields information that can be used either within the system 128 or used by other applications as, for example, context information for error messages, or as data written to a log file for purposes of analysis. The log file can be used to generate a lineage interface 130, for example, so that the lineage information can be visualized.

In various embodiments, the lineage generation system 128 makes use of tree manipulation routines (e.g. add, delete, move, etc.) and/or tree information that exist within query planning or optimization engines. Thus, the query lineage information can be provided in a manner that is transparent to an author of a query.

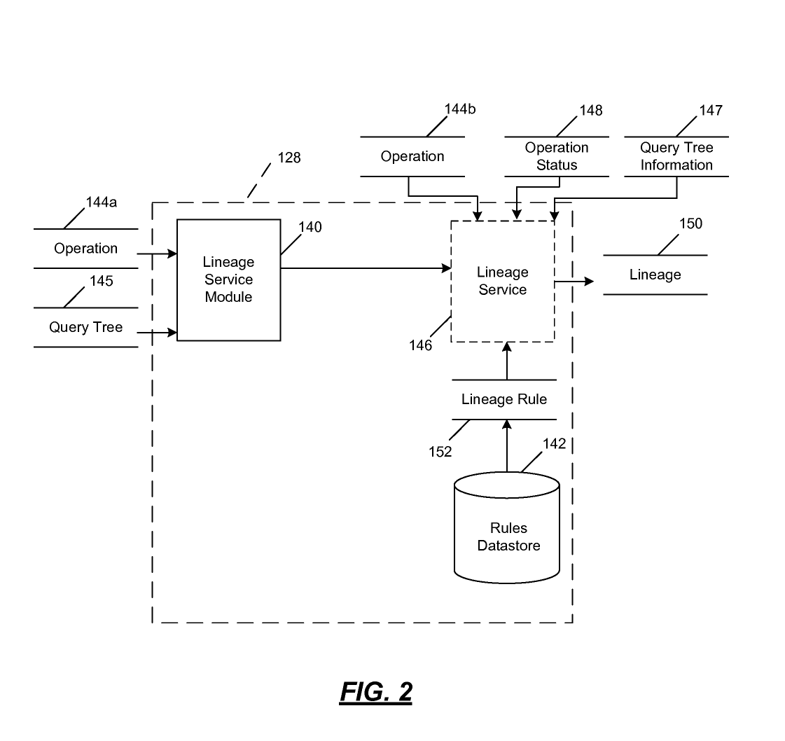

Turning now to FIG. 2, the lineage generation system 128 is shown in more detail in accordance with an exemplary embodiment. The lineage generation system 128 includes one or more sub-modules and datastores. As can be appreciated, the sub-modules can be implemented as software, hardware, firmware, a combination thereof, and/or other suitable components that provide the described functionality. As can be appreciated, the sub-modules and datastore can reside on one or more computer systems. As can further be appreciated, the sub-modules shown in FIG. 2 can be combined and/or further partitioned to similarly generate a lineage. In this example, the lineage generation system 128 includes a lineage service module 140, and a rules datastore 142.

The lineage service module 140 receives as input an operation 144a. The operation 144a can be generated based on a developer's interaction with a query planning or optimization engine (not shown). In one example, the operation indicates the construction of a new query tree 145. Based on the operation 144a, the lineage service module 140 launches a lineage service 146 and associates the lineage service 146 with the planning of the particular query tree 145. The lineage service 146 monitors future operations 144b performed on the query tree 145 associated with the query, query tree information 147, and/or an operational status 148. Based on the operations 144b, the query tree information 147, and/or the operational status 148, the lineage service 146 interfaces with the rules datastore 142 to develop a query lineage 150.

The rules datastore 142 stores one or more lineage rules 152. Each lineage rule 152 can be associated with a particular operation 144b and/or query tree information 147. The lineage rules 152 can include logic to capture the relationships of nodes that remain in the query tree 145 at any point in time with the nodes in the original query tree 145 and vice versa. In some cases, lineage information may be lost (some information may actually not be important in the final query) while, in many cases, there is a many-to-many relationship between nodes in the current state of a query tree and nodes in the initial query tree 145.

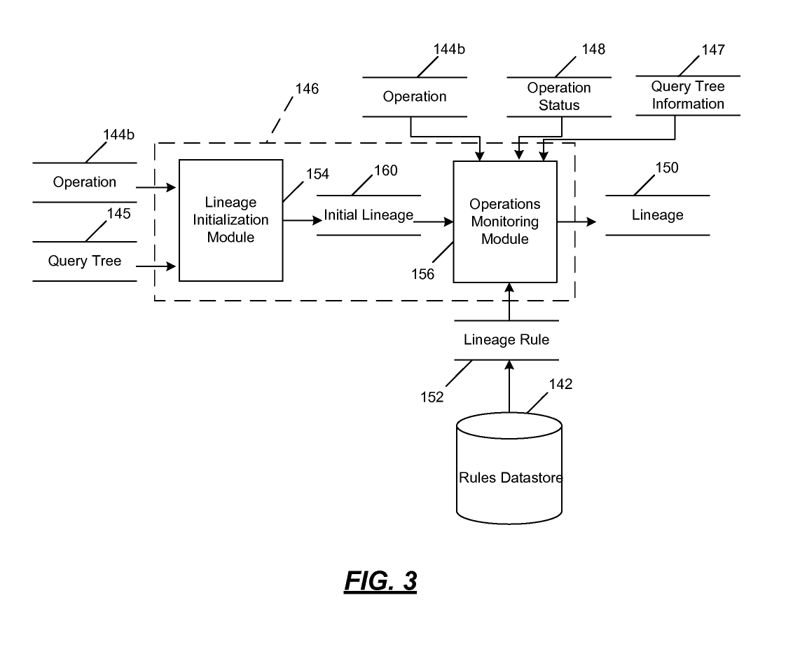

Turning now to FIG. 3, the lineage service 146, includes, for example, a lineage initialization module 154, and an operations monitoring module 156. The lineage initialization module 154 receives as input the initial operation 144a, and the initial query tree 145. Based on the initial operation 144a and the query tree 145, the lineage initialization module 154 assigns to each node in the query tree 145 an initial lineage 160. For example, the lineage for each node includes a container of the nodes upon which the node's existence is dependent and is initially a reference to itself (either as a reference/pointer to the node within a copy of the initial query tree, or as a unique identifier, one of which is assigned to each node in the initial query tree, and to each node subsequently produced during the planning process). In various embodiments, a reference to the lineage service 146 is retained within each node in the query tree 155 as the lineage service 146 retains information across individual query tree manipulation operations 144b.

The operations monitoring module 156 then monitors further operations 144b that are performed on that particular query tree 145 and that represent a transformation or manipulation of the query tree 145. The operations 144b can include, but are not limited to, for example, add, delete, and move. The operation notification 144b is typically generated at the beginning of the application of each transformation or manipulation to the query tree 145. While or after the operations 144b are applied to the query tree 145 (e.g. adding a node, deleting a node, move a node, etc.), the lineage service module 140 updates the lineage 150 associated with one or more nodes based on the operations 144b, and/or the query tree information 147 and further based on one or more rules 152 stored in the rules datastore 142.

For example, the operations monitoring module 156 associates one or more operations 144b and/or query tree information 147 with a particular rule 152. The rule 152 and/or the logic that implements the rule 152 is retrieved from the rules datastore 142. The rule 152 and/or the logic is then performed to determine the appropriate lineage 150.

In one example, when the operations 144b indicate transformations such as, but are not limited to, delete, exchange, add, and/or move, the following rules 152 can be defined. The rule 152 associated with the delete operation transfers the lineage of the deleted node to that of the deleted node's parent. The rule 152 associated with the exchange operation copies the lineage of the target node to the node being moved. The rule 152 associated with the add operation provides for no effect upon the lineage. The rule 152 associated with the move operation provides for no effect upon the lineage. The rule 152 associated with the move children operation transfers the lineage of the parent node to the child nodes before moving the child nodes. If there are no children, the node's lineage is moved to the parent node.

In various embodiments, some operations 144b cause an immediate transfer of lineage while others have a delayed impact. In instances where the operations indicate some form of removal (e.g., detach, exchange, extract, delete, etc.) of a node from the query tree 145, it is possible within the same transformation that that node may be re-inserted into the query tree 145. Thus, the completion of the lineage 150 is delayed until the re-insertion of the node.

For example, when the operation 144b specifies some form of removal or deletion of a node from the query tree 145, in various embodiments, a rule 152 is applied to determine the possible recipients of the removed or deleted node's lineage 150. The operations monitoring module 156 then temporarily stores this information with the removed node until the node is re-inserted into the query tree 145 or the node is permanently deleted.

After the transformation is complete, the operations monitoring module 156 is informed via the operation status 148 that the transformation has been completed. The operations monitoring module 156 then completes the lineage manipulations associated with the transformation based on the temporarily stored information. The operations monitoring module 156 determines whether any of the operations 144b re-insert any removed nodes back into the query tree 145. In such a case, the rules 152 provide that the lineage 150 remains with the re-inserted node. On the other hand, it is possible that the node is not re-inserted into the query tree 145. In such a case, the rules 152 provide that the corresponding lineage 150 is transferred to other nodes in the query tree and/or should be deleted.

For example, if the removed node has a parent node, the rules 152 copy the lineage 150 of the removed node to the parent node. Otherwise, if the removed node has no parent, the lineage 150 is deleted.

In various embodiments, the rules 152 may be based on query tree information rather the operations 144b. For example, the rules 152 may be based on the type of a node, or information about the node relative to itself.

In the example above, moving a node within a query tree 155 has no impact on the node's lineage; the lineage simply transfers along with the node. However, in another example, it may be the case that moving a node from one area of the query tree 155 to another area may have bounds in which this behavior is no longer applicable.

For example, if a node of type ‘X’ always exists as a descendant (direct or otherwise) of another node of type ‘Z’, a particular implementation may apply the default ‘move’ semantics for query lineage if the ancestor of type ‘Z’ does not change. The associated rule 152 may be that if the ancestor of type ‘Z’ should change as the consequence of a move operation, that the lineage of the node is transferred to, for example, the parents. In this example the rule 152 employed to perform the lineage transfer is based on more than simply the operations 144b being performed and is not restricted to the node or the query tree 155 in which it exists.

As can be appreciated, the above rules 152 can be modified to accommodate various implementations of a query planning or optimization engine. For example, similar rules can be applied to different operations or different query tree information.

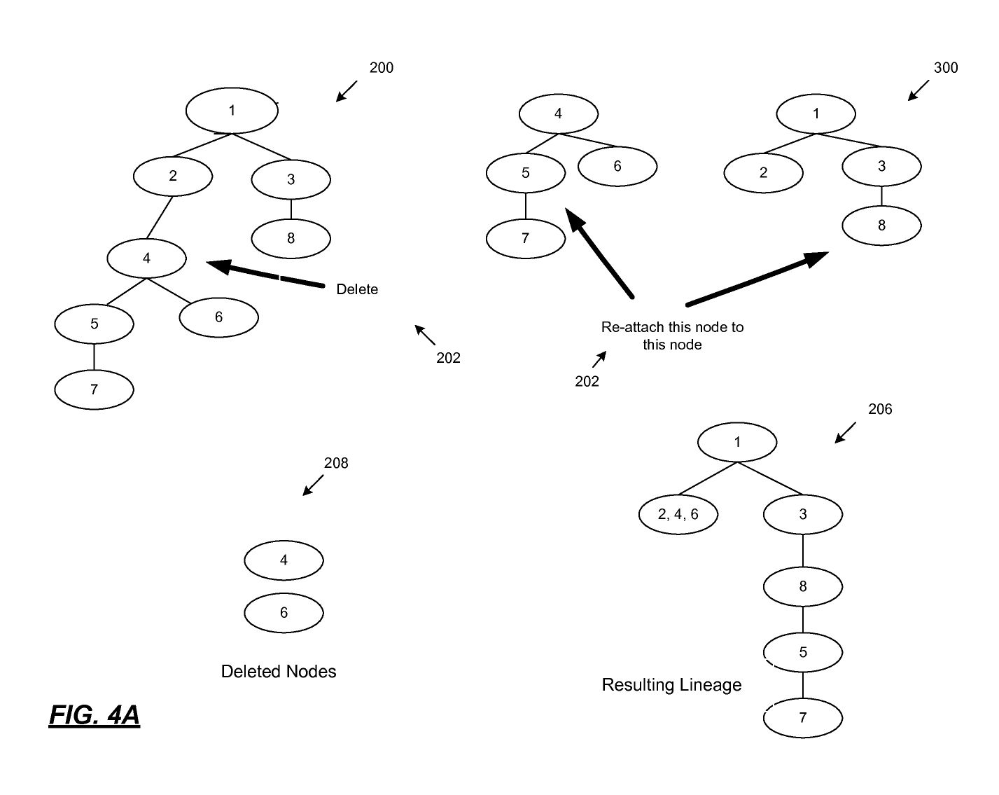

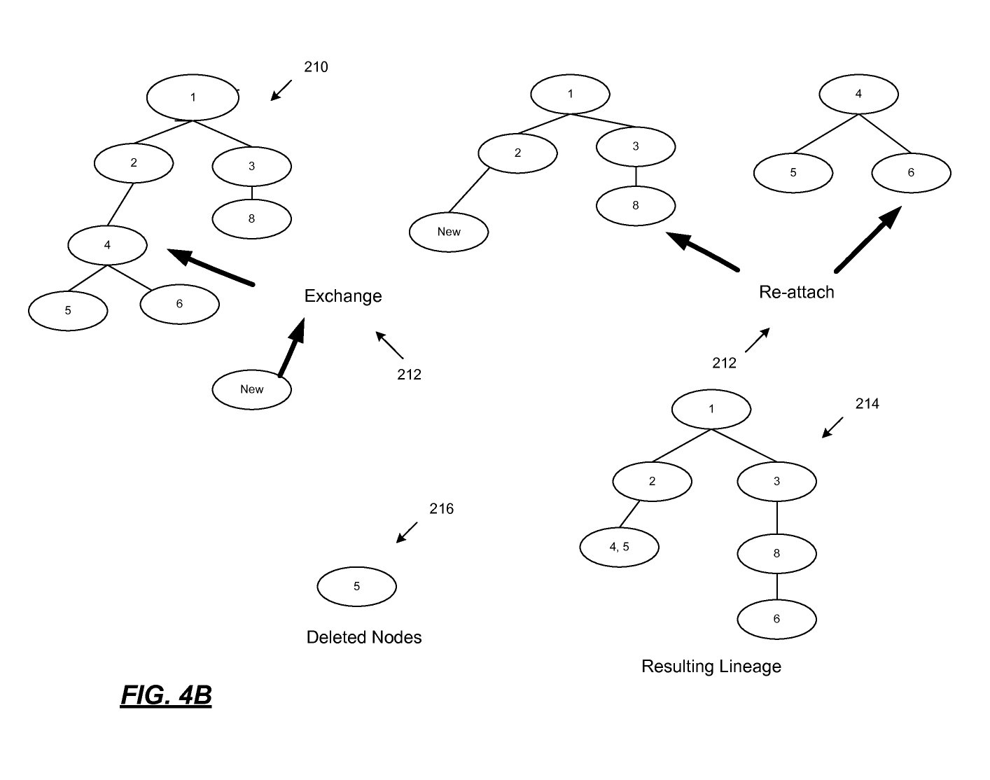

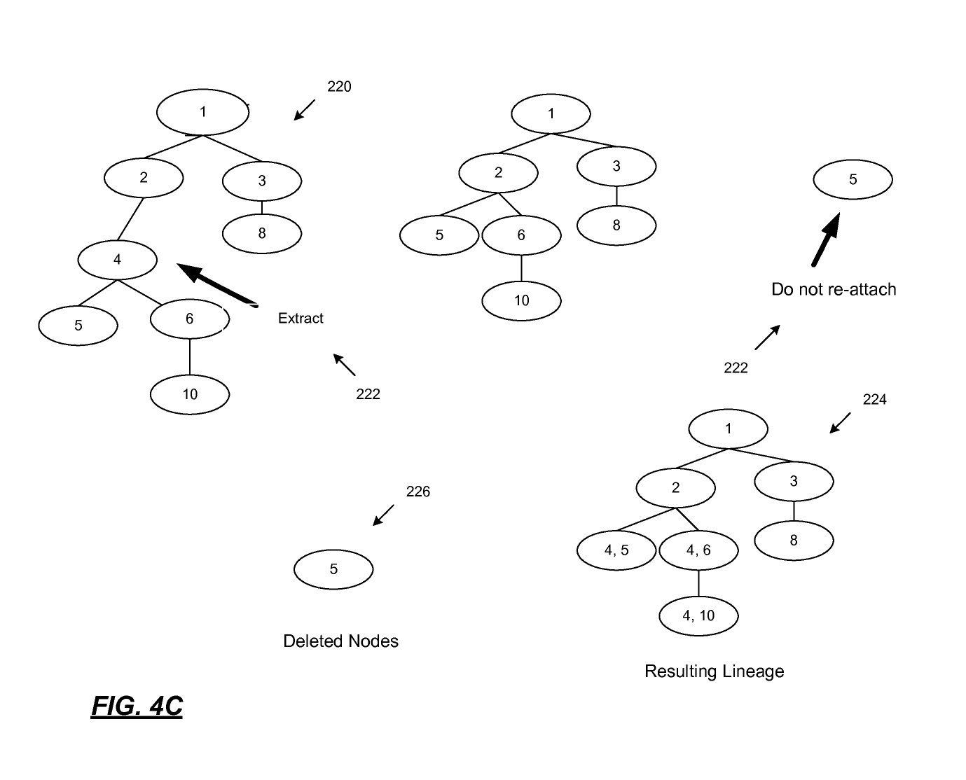

FIGS. 4A-4B illustrate exemplary lineages that result from particular operations performed on various query trees. As can be appreciated, similar lineages can be generated based on query tree information and/or operations associated with query trees.

FIG. 4A illustrates a first query tree 200 including nodes one through eight. The operations 202 indicate that node four is deleted and node five is re-attached to node eight. The resulting lineage 206 includes the lineage of the deleted nodes being copied to the parent node two. The deleted nodes 208 thus, include node four and node six.

FIG. 4B illustrates a lineage for a second query tree 210 that include nodes one through six and node eight. The operations 212 indicate that node four is exchanged with a new node and the node six is attached to the node eight. The resulting lineage 214 includes the lineage of the deleted nodes four and five being copied to the new node. The deleted nodes 216 thus, include node five.

FIG. 4C illustrates a lineage for a third query tree 220 that includes nodes one through six, node eight, and node ten. The operations 222 indicate that node four is extracted and is not reattached. The resulting lineage 224 includes the lineage for node four being copied to the child nodes five, six, and ten. The deleted nodes 226 thus, include node five.

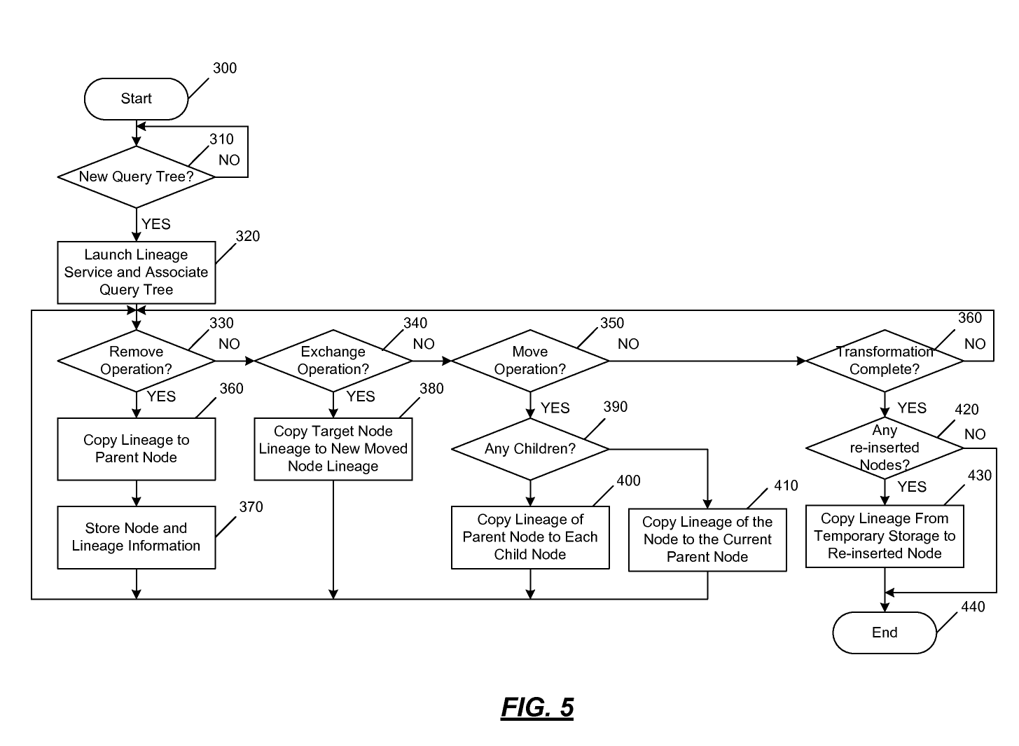

Turning now to FIG. 5 and with continued reference to FIGS. 2 and 3, a flowchart illustrates a lineage generation method that can be performed by the lineage generation system 128 of FIGS. 2 and 3 in accordance with an exemplary embodiment. As can be appreciated in light of the disclosure, the order of operation within the method is not limited to the sequential performance as illustrated in FIG. 5, but may be performed in one or more varying orders as applicable and in accordance with the present disclosure. As can be appreciated, one or more steps can be added or deleted from the method without altering the spirit of the method.

In one example, the method may begin at 300. The operations 144a from, for example, a query planning or optimization engine, are monitored at 310. If the operations 144a indicate that a new query tree 145 is constructed at 310, a lineage service 146 is launched and is associated with the new query tree 145 at 320. If, however, a new query tree 145 is not constructed at 310, the method continues with monitoring the operations 144a until a new query tree 145 is constructed at 310.

Once launched, the lineage service 146 then monitors all future operations 144b on the associated query tree 145 and/or query tree information 147 at 330-350. For example, if the operation 144b indicates a remove operation at 330, the lineage 150 is copied from the removed node to the parent node at 360. The lineage information and the node information for the removed node are then temporarily stored for subsequent evaluation at 370.

If, however, the operation 144b indicates an exchange operation at 340, the lineage 150 of the target node is copied to the node being moved at 380. If the operation indicates a move operation at 350, it is determined whether the node has children at 390. If the node has children at 390, the lineage 150 of the parent node is copied to the lineage 150 for each child node at 400. If the node does not have any children at 390, the lineage 150 of the node is moved to the parent node at 410.

If, however, the operation does not indicate a remove operation, an exchange operation, or a move operation at 330-350, the operation status 148 is evaluated at 360. If the operation status 148 indicates that the transformation is complete at 360, it is determined whether any of the removed nodes have been re-inserted at 420. If a removed node has been re-inserted into the query tree 145 at 420, the temporarily stored information for the node, including the lineage 150, is copied to the re-inserted node at 430. Thereafter, the method may end at 440.

As can be appreciated, the flowcharts and block diagrams in the Figures illustrate the architecture, functionality, and operation of the possible implementations of systems, methods, and computer program products according to various embodiments of the present disclosure. In this regard, each block in the flowchart or block diagrams may represent a module, segment, or a portion of code, which comprises one or more executable instructions for implementing the specified logical functions. It should also be noted that, in some alternative implementations, the functions noted in the block may occur out of the order noted in the Figures. For example, two blocks shown in succession may, in fact, be performed substantially concurrently, or the blocks may sometimes be performed in the reverse order, depending upon the functionality involved. It will also be noted that each block of the block diagrams and/or flowcharts, and combinations of blocks in the block diagrams and/or flowcharts can be implemented by special purpose hardware-based systems that perform the specified functions or acts, or combinations of special purpose hardware and computer instructions.

As one example, one or more aspects of the present disclosure can be included in an article of manufacture (e.g., one or more computer program products) having, for instance, computer usable media. The media has embodied therein, for instance, computer readable program code means for providing and facilitating the capabilities of the present disclosure. The article of manufacture can be included as a part of a computer system or provided separately.

Additionally, at least one program storage device readable by a machine, tangibly embodying at least one program of instructions executable by the machine to perform the capabilities of the present disclosure can be provided.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

While a preferred embodiment has been described, it will be understood that those skilled in the art, both now and in the future, may make various improvements and enhancements which fall within the scope of the claims which follow. These claims should be construed to maintain the proper protection for the disclosure first described.

The terminology used herein is for the purpose of describing particular embodiments only and is not intended to be limiting of the invention. As used herein, the singular forms “a”, “an” and “the” are intended to include the plural forms as well, unless the context clearly indicates otherwise. The corresponding structures, features, materials, acts, and equivalents of all means or step plus function elements in the claims below are intended to include any structure, material, or act for performing the function in combination with other claimed elements as specifically claimed. The disclosure has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

What is claimed is:

1. A method of generating a query lineage, comprising:
performing on a processor,
evaluating at least one of query tree information and operations performed on a query tree, where the query tree includes one or more nodes;
identifying a lineage rule based on the at least one of query tree information and operations; and
generating a lineage of the query tree based on the lineage rule.

2. The method of claim 1 further comprising maintaining a lineage rule datastore that stores one or more lineage rules.

3. The method of claim 1 wherein the evaluating, the identifying, and the generating are performed while the operations are being performed on the query tree.

4. The method of claim 1 further comprising temporarily storing lineage information when the operation is a remove type operation.

5. The method of claim 4 further comprising including the lineage information in the lineage when the operation is a re-insert type operation.

6. The method of claim 1 wherein the generating the lineage comprises executing logic associated with the lineage rule to generate the lineage of the query tree.

7. The method of claim 1 wherein the operations include at least one of delete, exchange, add, and move.

8. The method of claim 7 wherein when the operation is delete, the associated rule copies lineage information from a deleted node of the query tree to a parent node of the query tree.

9. The method of claim 7 wherein when the operation is exchange, the associated rule copies lineage information from a target node of the query tree to a node being exchanged of the query tree.

10. The method of claim 7 wherein when the operation is move, determining whether the node of the query tree is associated with a child node, and wherein if the node is associated with a child node, the associated rule copies lineage information from the node to the child node.

11. A system for generating a query lineage, comprising:
a computer readable medium, including:
a lineage rules datastore that stores at least one lineage rule;
a lineage service that evaluates at least one of operations performed on a query tree and query tree information, where the query tree includes one or more nodes, and generates a lineage of the query tree based on the at least one of operations and query tree information and a lineage rule from the lineage rule datastore.

12. The system of claim 11 wherein the lineage service performs the generating while the operations are being performed on the query tree.

13. The system of claim 11 wherein the lineage service temporarily stores lineage information when the operation is a remove type operation.

14. The system of claim 13 wherein the lineage service includes the lineage information in the lineage when the operation is a re-insert type operation.

15. The system of claim 11 wherein the lineage service generates the lineage by executing logic associated with the lineage rule to generate the lineage of the query tree.

16. The system of claim 11 wherein the operations include at least one of delete, exchange, add, and move.

17. The system of claim 16 wherein when the operation is delete, the associated rule copies lineage information from a deleted node of the query tree to a parent node of the query tree.

18. The system of claim 16 wherein when the operation is exchange, the associated rule copies lineage information from a target node of the query tree to a node being exchanged of the query tree.

19. The system of claim 16 wherein when the operation is move, the lineage service determines whether the node of the query tree is associated with a child node, and wherein if the node is associated with a child node, the associated rule copies lineage information from the node to the child node.
